(19) United States
(12) Patent Application Publication
(10) Pub. No.: US 2024/0051284 A1
(43) Pub. Date: Feb. 15, 2024

(54) FILM LAMINATING MACHINE AND FILM LAMINATING METHOD

(71) Applicant: Jie WU, Shenzhen (CN)

(72) Inventor: Jie WU, Shenzhen (CN)

(21) Appl. No.: 17/885,563

(22) Filed: Aug. 11, 2022

(51) Int. Cl. B32B 37/00; B32B 7/06

(52) U.S. Cl. CPC B32B 37/0046; B32B 7/06; B32B 7/12

(57) ABSTRACT

The present invention discloses a film laminating machine and a film laminating method, which are used for laminating a protection film on a screen of equipment to be laminated with a film. The protection film includes a protection film body and a release film which are separably connected; and the release film can be pulled to be separated from the protection film body. The film laminating machine provided in the technical solution of the present invention can save materials required for manufacturing.

### TECHNICAL FIELD

The present invention relates to the technical field of film lamination, particularly to a film laminating machine and a film laminating method.

### BACKGROUND

At present, protection films need to be laminated to screens of various kinds of equipment to be laminated with a film (such as a mobile phone). However, when a protection film is laminated to equipment to be laminated with a film, a placement shell is required to fix the equipment to be laminated with a film. More materials are used for structural arrangement of the existing placement shell. In addition, in the prior art, a film cannot be laminated to a screen until dust is removed from the screen first. There are many separate steps, easily resulting in re-adsorption of dust and the like to the screen. Therefore, it is necessary to provide a film laminating machine that saves manufacturing materials, a dust-removal-facilitated protection film, and a corresponding film laminating method.

### SUMMARY

Implementations of the present invention provide a film laminating machine and a film laminating method, and aims at saving materials required for manufacturing of the film laminating machine.

A film laminating machine according to an implementation of the present invention is used for laminating a protection film on a screen of equipment to be laminated with a film. The protection film includes a protection film body and a release film which are separably connected; the release film can be pulled to be separated from the protection film body; the film laminating machine includes a placement shell, a plurality of equipment fixing bulge parts and a protection film fixing structure; the placement shell is provided with a placement surface fitted to the protection film; the equipment fixing bulge parts are disposed at intervals around the placement surface to fix the equipment to be laminated with a film; the equipment fixing bulge parts form a first avoiding space on a pulling path of the release film; the first avoiding space is fitted to the release film; and the protection film fixing structure is arranged on the placement shell to limit and fix the protection film body in a pulling direction of the release film.

According to the film laminating machine of the above implementation, the equipment to be laminated with a film such as a mobile phone can be fixed through the plurality of equipment fixing bulge parts disposed at intervals, and most structures at an edge of the film laminating machine can be eliminated, so that materials required for manufacturing of the film laminating machine can be saved; and in addition, the weight of the film laminating machine can be reduced.

Further, wherein the equipment fixing bulge parts form a second avoiding space opposite to the first avoiding space, and the second avoiding space is fitted to the release film.

Further, wherein each equipment fixing bulge part comprises a connecting pillar body and a fixing lug; a lower end of the connecting pillar body is connected to the placement shell, and an upper end is connected to the fixing lug that laterally extends; the equipment fixing bulge parts comprise a first equipment fixing bulge part that forms the first avoiding space, and a second equipment fixing bulge part that forms the second avoiding space; and the first avoiding space and the second avoiding space are respectively formed between the fixing lugs of the first equipment fixing bulge part and the second equipment fixing bulge part and the placement shell.

Further, wherein two first equipment fixing bulge parts are configured, and the two first equipment fixing bulge parts are arranged on two opposite sides of the pulling path of the release film.

Further, wherein the placement surface is concave, so as to form a placement slot in the placement shell; and the placement slot is fitted to the protection film.

Further, wherein the placement shell comprises a first wall body located at a bottom of the placement slot, a second wall body located at a side portion of the placement slot, and a third wall body connected to an outer end of the second wall body; and the protection film fixing structure is arranged on the second wall body.

Further, wherein the protection film fixing structure is configured as a film limiting bulge part; and the film limiting bulge part is arranged at one end of the second wall body close to the pulling direction of the release film.

Further, wherein a plurality of film limiting bulge parts are disposed at intervals.

Further, wherein an avoiding via hole is formed in the placement shell to allow a hand of a user to pass.

An implementation of the present invention provides a protection film assembly, and aims to provide a dust-removal-facilitated protection film.

The present invention further provides a protection film assembly of one implementation to protect a screen of equipment to be laminated with a film. The protection film assembly includes a protection film body, a release film and a dust removal block; the protection film body is provided with a laminating surface used for being laminated to the screen; the release film includes a fitting portion separably fitted to the laminating surface, and a handle portion used for pulling the release film to be separated from the protection film body; the handle portion includes a first end connected to the fitting portion, and a second end for pulling; the handle portion is superimposed on one side of the fitting portion away from the protection film body; and the dust removal block is arranged on a surface of the first end facing away from the fitting portion, and is used for resisting against and sweeping across the screen.

According to the protection film assembly of the above implementation, during film laminating operation, the screen of the equipment to be laminated with a film is placed on the handle portion of the release film in a resisting manner; the dust removal block resists against one end of the screen; a user can press the mobile phone and the protection film assembly; and furthermore, the handle portion is pulled to separate the release film from the protection film body. It can be understood that by means of the dust removal block on the release film, when the release film is pulled to be separated from the protection film body, the dust removal block resists against and sweeps the screen of the equipment to be laminated with a film, so that dust can be removed from the screen; and moreover, the protection film body can be laminated on the screen after the dust removal step.

Further, wherein the first end is provided with an exposed film body beyond an outer side of an edge of the protection film body close to the first end, and part of the dust removal block is arranged on one side of the exposed film body facing the screen.

Further, wherein the dust removal block is fixedly arranged at the first end.

Further, wherein the dust removal block is fixedly arranged at the first end by means of adhesion.

Further, one side surface of the dust removal block close to the first end is adhered to the first end.

Further, an edge of one side surface of the dust removal block facing away from the first end is adhered by part of an adhesive; and a remaining portion of the adhesive is adhered to the first end.

Further, wherein the dust removal block is configured as clean cloth.

Further, wherein the release film is configured as a flexible foldable film.

Further, wherein the handle portion and the fitting portion are integrally formed.

Further, wherein the first end and the second end are located at two opposite ends of the handle portion along a lengthwise direction of the protection film body; and a length of the handle portion is greater than that of the protection film body, so that the second end is conveniently pulled.

Further, wherein a width of the dust removal block is fitted to a width of the protection film body.

Further, a size of the dust removal block along a lengthwise direction of the protection film body is less than a length of the protection film body.

Further, wherein a width of the handle portion gradually decreases from the first end to the second end.

The present invention further provides a film laminating method of one implementation, including: S1, aligning the protection film body of the protection film assembly with the protection film fixing structure of the film laminating machine for resisted placement, and limiting and fixing the protection film assembly through the protection film fixing structure; S2, aligning the screen of the equipment to be laminated with a film with the film laminating machine, placing the screen on an upper side of the placement surface of the placement shell of the film laminating machine, and limiting and fixing the equipment to be laminated with a film through the fixing bulge parts; and S3, pulling the handle portion of the protection film assembly at a constant speed until the release film is completely separated from the protection film body, and completing film lamination.

The film laminating machine of the implementation of the present invention has the beneficial effect of saving materials; and furthermore, the protection film is provided with the dust removal block, so that dust can be removed from the screen in the film laminating process.

Additional aspects and advantages of the present invention will be provided in the following descriptions, part of which will become apparent from the following descriptions or be learned through the practice of the present invention.

### BRIEF DESCRIPTION OF DRAWINGS

FIG. 1 is a schematic structural exploded diagram of a film laminating machine assembly according to an implementation of the present invention;

FIG. 2 is a schematic structural diagram of a film laminating machine according to an implementation of the present invention;

FIG. 3 is an enlarged diagram of Position A in FIG. 2.

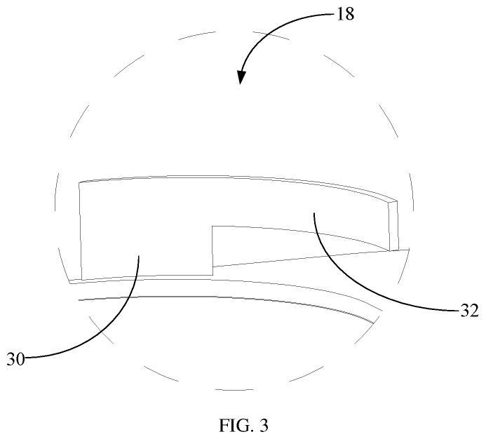

### DETAILED DESCRIPTION OF THE EMBODIMENTS

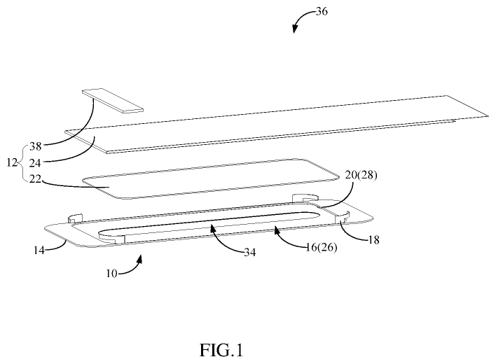

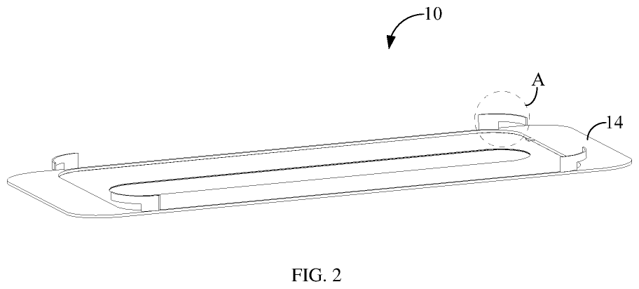

Referring to FIG. 1 and FIG. 2 together, the present invention provides a film laminating machine 10 and a film laminating machine assembly 36, which can be used for laminating a protection film assembly 12 on a screen of equipment to be laminated with a film.

Referring to FIG. 1 and FIG. 2, in some implementations of the present invention, the film laminating machine is used for laminating a protection film assembly 12 on a screen of equipment to be laminated with a film. A protection film 2 includes a protection film body 22 and a release film which are separably connected; the release film can be pulled to be separated from the protection film body 22; the film laminating machine 10 includes a placement shell 14, a plurality of equipment fixing bulge parts 18 and a protection film fixing structure 20; the placement shell 14 is provided with a placement surface fitted to the protection film assembly 12; the equipment fixing bulge parts 18 are disposed at intervals around the placement surface to fix the equipment to be laminated with a film; the equipment fixing bulge parts 18 form a first avoiding space on a pulling path of the release film 24; the first avoiding space is fitted to the release film 24; and the protection film fixing structure 20 is arranged on the placement shell 14 to limit and fix the protection film body 22 in a pulling direction of the release film 24.

According to the protection film assembly 12 of the above implementation, the equipment to be laminated with a film such as a mobile phone can be fixed through the plurality of equipment fixing bulge parts 18 disposed at intervals, and most structures at an edge of the film laminating machine 10 can be eliminated, so that materials required for manufacturing of the film laminating machine 10 can be saved; and in addition, the weight of the film laminating machine 10 can be reduced.

Specifically, during film laminating operation, the protection film assembly 12 is placed on the placement surface 16; the screen of the equipment to be laminated with a film is placed on the film laminating machine 10 in a manner of resisting against the protection film assembly 12; furthermore, the equipment to be laminated with a film is fixed by the equipment fixing bulge parts 18; and the protection film fixing structure 20 can limit and fix the protection film assembly 12. When the release film 24 of the protection film assembly 12 is pulled to be separated from the protection film body 22, the protection film body 22 can be limited by the protection film fixing structure 20, without moving and affecting the film laminating effect. Particularly, the plurality of equipment fixing bulge parts 18 are disposed at intervals around the placement surface 16, that is, the plurality of equipment fixing bulge parts 18 are independent of each other, so that the materials required for manufacturing of the film laminating machine 10 can be saved. It can also convenient for a user to pass through a clearance space between the equipment fixing bulge parts 18 with a hand to remove the film laminating machine 10 from the equipment to be laminated with a film.

The protection film assembly 12 of the implementation of the present invention has at least the above-mentioned beneficial effects.

In the related art, the protection film assembly 12 with a protection function needs to be laminated on the screen of the equipment to be laminated with a film to protect the screen. It should be noted that the equipment to be laminated with a film mentioned in the implementation of the present invention may include, but not limited to, a mobile phone, a flat computer and intelligent glasses.

The film laminating machine 10 of this implementation is used for laminating the protection film assembly 12 on the equipment to be laminated with a film (which is described by taking a mobile phone as an example). A size and shape of the protection film assembly 12 are fitted to the mobile phone to be laminated with a film. In actual production, a shape and size of the protection film body 22 can be designed according to any types of mobile phones, so as to adapt to different mobile phones.

In this implementation, the placement surface 16 of the placement shell 14 of the film laminating machine 10 is located on an upper side, which can be used to place equipment such as a mobile phone, and the other surface of the placement shell 14 facing away from the placement surface 16 can be used to be placed on an object such as a tabletop or held by a human hand. The size and shape of the placement surface 16 adapt to the size and shape of the equipment to be laminated with a film, for example, the size and shape of the mobile phone.

When the equipment to be laminated with a film is placed on the placement surface 16, the equipment fixing bulge parts 18 can limit and fix the equipment, and a user can hold the placement shell 14 and the equipment to be laminated with a film to perform a film laminating operation. In this implementation, there are a plurality of equipment fixing bulge parts 18 which are arranged around the placement surface 16 to limit and fix the equipment to be laminated with a film on the placement surface 16. It should be noted that the shape and structure of each equipment fixing bulge part 18 is based on the ability to limit and fix the equipment to be laminated with a film. In this implementation, the equipment fixing bulge part 18 extends upward for a certain distance which is determined by the size of the equipment to be laminated with a film. There is a clearance space between the plurality of equipment fixing bulge parts 18, that is, the plurality of equipment fixing bulge parts 18 can be regarded as independent bulges from each other, so that the materials required for manufacturing of the film laminating machine 10 can be reduced, and the weight can be reduced. In addition, since there is no connecting portion in a lateral direction between the equipment fixing bulge parts 18, the equipment fixing bulge parts are easier to deform, that is, the equipment to be laminated with a film can be conveniently snapped into a placement space enclosed by the plurality of equipment fixing bulge parts 18. Furthermore, there are clearance spaces between the plurality of equipment fixing bulge parts 18, so that the user can remove the equipment to be laminated with a film from the film laminating machine 10 through these clearance spaces by a hand. Optionally, the equipment fixing bulge parts 18 are configured as elastic members, which can be elastically deformed in the lateral direction, so that the equipment to be laminated with a film is conveniently snapped into the placement space enclosed by the plurality of equipment fixing bulge parts 18.

The protection film assembly 12 of the present invention includes a protection film assembly 12, and the protection film includes a protection film body 22, a release film 24 and a dust removal block. The protection film body 22 is provided with a laminating surface used for being laminated to the screen; the release film 24 includes a fitting portion separably fitted to the laminating surface, and a handle portion used for pulling the release film 24 to be separated from the protection film body 22; the handle portion includes a first end connected to the fitting portion, and a second end for pulling; the handle portion can be superimposed on one side of the fitting portion away from the protection film body 22; and the dust removal block is arranged on a surface of the first end facing away from the fitting portion, and the dust removal block 38 is used for resisting against and sweeping across the screen.

In the protection film assembly 12 of the present invention, the protection film body 22 is composed of six layers, specifically including a basic protection film layer, a hard structural layer, a reinforcing layer, an adhesive layer, a film material layer and a silica gel layer. Preferably, in order to filter out short-wave light from the screen, a light-transmitting film for preventing short-wave light is further provided on the basis of the six layers of materials, and the light-transmitting film for preventing short-wave light includes short-wave light absorbing resin particles. The short-wave light absorbing resin particles include resin and short-wave light absorbing organic dyes. A material for the reinforcing layer is a triacetate cellulose film, which helps to provide hardness and wear resistance. A material for the film material layer is SRF. Preferably, the SRF includes a base material layer, an anti-glare layer and a high-refraction antistatic layer, so that the influence, caused by a high temperature in a curing process, on the effect of the film material layer can be avoided.

The present invention further provides a method for preparing the protection film body 22, including the following steps:

An adhesive is uniformly coated on a single side surface of the release film 24 and is heated to be cured within a temperature range of 100-150° C., preferably 110° C., to obtain an adhesive layer coated with the release film 24; a surface of a reinforcing layer is uniformly coated with a hardener and is then cured by ultraviolet light to obtain a reinforcing layer with a hard structural layer; a surface of a film material layer is uniformly coated with silica gel and is then heated to be cured within a temperature range of 100-150° C. to obtain a film material layer with a silica gel layer; and the adhesive layer is torn off and is pressed and compounded together with the film material layer with the silica gel layer to obtain the protection film body 22.

According to the protection film assembly 12 of the above implementation, during film laminating operation, the screen of the equipment to be laminated with a film is placed on the handle portion of the release film 24 in a resisting manner; the dust removal block 38 resists against one end of the screen; a user can press the mobile phone and the protection film assembly 12; and furthermore, the handle portion is pulled to separate the release film 24 from the protection film body 22. It can be understood that by means of the dust removal block 38 on the release film 24, when the release film 24 is pulled to be separated from the protection film body 22, the dust removal block 38 resists against and sweeps the screen of the equipment to be laminated with a film, so that dust can be removed from the screen; and moreover, the protection film body 22 can be laminated on the screen after the dust removal step. Moreover, the protection film assembly 12 of the implementation of the present invention has only two layers of film bodies (i.e., the release film 24 and the protection film body 22), which is simpler in structure and more material-saving than other protection films with more than two layers of film bodies. It can be understood that the film laminating process is simple, convenient and efficient, and at the same time, the protection film body after the release film is removed does not need to be moved or exposed for a long time, thereby reducing the possibility of dust contamination on the protection film body. In addition, dust that falls onto a surface of the equipment to be laminated with a film before lamination can also be cleared away in the laminating process.

In the implementation of the present invention, the user can directly carry out cleaning by pressing the dust removal block. However, in the prior art, first, dust removal and separation are separated, which will lead to secondary pollution; second, a special tool or an auxiliary method is required to ensure a pressure between a dust removal device as well as the protection film body and the screen, so that the operation process is complicated, and film lamination easily fails due to carelessness.

The protection film assembly 12 of the implementation of the present invention has at least the above-mentioned beneficial effects.

In the related art, the protection film with a protection function needs to be laminated on the screen of the equipment to be laminated with a film to protect the screen. It should be noted that the equipment to be laminated with a film mentioned in the implementation of the present invention may include, but not limited to, a mobile phone, a flat computer and intelligent glasses.

The protection film body 22 of this implementation is used for being laminated on the equipment to be laminated with a film (which is described by taking a mobile phone as an example). A size and shape of the protection film body 22 are fitted to the mobile phone to be laminated with a film. In actual production, the shape and size of the protection film body 22 can be designed according to any types of mobile phones, so as to adapt to different mobile phones. The protection film body 22 can be divided into one surface (a screen laminating surface) for being laminated on the screen of the mobile phone, and the other surface according to functions. When the laminating surface is in direct contact with the screen, the protection film body 22 can be laminated on the screen, so that the screen can be protected.

When the release film 24 is fitted to the protection film body 22, the release film 24 can protect the laminating surface. When the release film 24 is separated from the protection film body 22, the laminating surface can be laminated on the screen, that is, the protection film body 22 may be laminated on the screen. The connection between the release film 24 and the protection film body 22 is a separable connection. When the release film 24 is pulled in some directions, the release film 24 can be separated. A laminating portion of the release film 24 can be understood as all portions that are fitted to the protection film body 22, and a portion of the release film 24 other than the laminating portion can be understood as the handle portion. The handle portion can be superimposed on one side (the upper side) of the laminating portion away from the protection film body 22. It can also be understood that the release film 24 is folded into two layers, a lower side surface (a fitting surface) of the lower layer (a fitting portion) of which can be used for being fitted to the protection film body 22, and the upper layer (the handle portion) of which is folded to the upper side surface of the lower layer. Furthermore, the upper layer can be applied with a certain pulling force, so that the lower layer can be separated from the protection film body 22.

The dust removal block 38 is arranged at the first end of the handle portion. Specifically, the dust removal block is arranged on one side surface (the upper side) of the handle portion facing the mobile phone, and an edge of the dust removal block 38 is close to a joint between the first end and the fitting portion. When the screen resists against the handle portion of the release film 24, a pulling force is applied to the second end of the handle portion, and the direction of the pulling force is toward one side (i.e. the side where the second end is located) of the handle portion away from the dust removal block 38. When the pulling force is high enough, the release film 24 can be separated from the protection film body 22, and the dust removal block 38 can move from one end of the screen to the other end, so that the dust removal block 38 sweeps across a surface of the screen to remove dust from the screen. At the same time, after the release film 24 is separated from the protection film body, the laminating surface of the protection film body 22 can be laminated on the screen.

It should be pointed out that a size and shape of the dust removal block 38 in the implementation of the present invention are based on the fact that the screen can be dedusted after the dust removal block sweeps across the screen, and a specific material of the dust removal block 38 is subject to effective dust removal.

It can be understood that the protection film assembly 12 according to the implementation of the present invention, the screen can also be dedusted first while waiting for the film laminating machine to laminate a film to the mobile phone, so as to achieve the beneficial effect of uninterrupted dust removal and film lamination, so that the operation is simple and easy. Furthermore, secondary dust adsorption of the screen can be prevented during dust removal and film lamination. In particular, the release film 24 in the implementation of the present invention includes both the fitting portion and the handle portion, that is, the handle portion and the fitting portion can be understood as an integrated structure, and they are only formed by being folded and separated. In this way, the production and machining of the release film 24 can be simplified. Furthermore, only one layer of the release film 24 is disposed (it can be regarded as two connected layers after being folded), so that materials can be saved, and synthesis of multiple layers of release films 24 is not required. Optionally, the dust removal block 38 may be connected to the release film 24 in a manner of adhesion.

The protection film assembly 12 of the implementation of the present invention can be placed in one film laminating machine 10. The film laminating machine 22 may be provided with a fixing structure to fix the protection film body 22. The screen of the mobile phone and the like is placed in correspondence to the protection film assembly 12. Specifically, the screen is pressed on the release film 24 of the protection film assembly 12, and the upper side surface of the dust removal block 38 resists against the screen. A user can apply a pressure to enable the screen and the protection film assembly 12 to be in close contact, and pull the release film 24 at the same time to separate the release film 24 from the protection film body 22. Meanwhile, the dust removal block 38 can remove dust from the screen.

In some implementations, the first end is provided with an exposed film body beyond an outer side of an edge of the protection film body 22 close to the first end, and part of the dust removal block 38 is arranged on one side of the exposed film body facing the screen.

In this way, it is possible to achieve better dust removal on an end portion of the screen of the equipment to be laminated with a film.

In this implementation, the dust removal block 38 included in the protection film assembly 12 is disposed on the side surface (the upper side) of the handle portion facing the equipment to be laminated with a film. When the equipment to be laminated with a film is placed in correspondence to the protection film body 22, the dust removal block 38 and the exposed film body at the first end (the end where the dust removal block 38 is located) of the handle portion are exposed and protrudes from an outer edge of the screen. In this way, when the handle portion of the release film 24 is pulled by a hand, the release film 24 is separated from the protection film body 22. The exposed portion of the dust removal block 38 can gradually resist against the screen from the outer edge of the screen, so that the end portion of the screen can be better dedusted. In order to achieve this purpose, the first end of the release film 24 included in the protection film assembly 12 is provided the exposed film body protruding from the outer side of the edge of the protection film body 22 close to the first end, and part of the dust removal block 38 is arranged on the exposed portion.

However, the design is not limited to this. In other implementations, when the equipment to be laminated with a film is placed in correspondence to the protection film body 22, an edge of one end portion of the screen can be aligned with the outer edge of the dust removal block 38. At the same time, the outer edge of the screen is also aligned with the outer edge of the protection film body 22, as long as the dust removal block 38 can effectively remove dust from the screen.

In certain implementations, the dust removal block 38 is fixedly arranged at the first end.

It can be understood that the dust removal block 38 is fixedly arranged on the release film 24 (at the first end) to avoid separation in the dust removal process. It should be noted that the aforementioned dust removal block 38 is fixedly arranged at the first end, which means that the connection strength between the dust removal block 38 and the first end is high enough to prevent the dust removal block 38 from being separated from the first end during dust removal. In certain implementations, the dust removal block 38 is fixedly arranged at the first end in a manner of adhesion.

Adhesion can be used as a preferred implementation to realize that the dust removal block 38 is fixedly arranged at the first end. It can be understood that adhesion is an easy-to-operate connection method. In other implementations, the dust removal block 38 can also be fixedly arranged at the first end by other connection methods.

In certain implementations, one side surface of the dust removal block close to the first end is adhered to the first end.

In this implementation, the adhesion manner of the dust removal block can be used as an optional implementation. Specifically, the dust removal block can be adhered by, but not limited to, a double-sided tape or glue.

In certain implementations, an edge of one side surface of the dust removal block facing away from the first end is adhered by part of an adhesive; and a remaining portion of the adhesive is adhered to the first end.

In this way, curling during the movement of the dust removal block can be avoided.

Specifically, a periphery of the upper side surface (i.e. the side surface facing away from the first end) of the dust removal block may be adhered by a portion of the adhesive (such as a transparent adhesive tape), and the remaining portion of the adhesive may be adhered to the upper side surface (of the first end) of the release film, thus adhering the dust removal block to the release film. In particular, on a side edge of the dust removal block facing towards a pulling direction of the release film, the adhesive fixedly adheres the edge of the dust removal block to the release film, so that the dust removal block will not be curled by a friction force during movement.

In certain implementations, the dust removal block 38 is configured as clean cloth.

The clean cloth can be used as a preferred material. It can be understood that the clean cloth has the advantages of high dust removal ability, difficulty of being damaged, and the like, and is cheap and readily available. In other implementations, the dust removal block 38 may also be replaced by other materials.

In certain implementations, the release film 24 is configured as a flexible film capable of being folded.

In this way, the release film 24 can be easily folded.

It can be understood that the release film 24 is configured as the flexible film. Therefore, the release film 24 can be folded at any place, that is, the fitting portion of the release film 24 is fitted to the protection film body 22. The remaining portion of the release film 24 can be folded to form the handle portion when the fitting portion extends to any middle position of the release film 24. Of course, in this implementation, the size and shape of the handle portion are sufficient for applying a pulling force.

In certain implementations, the handle portion and the fitting portion are integrally formed.

It can be understood that it is convenient for production and manufacturing of the release film 24. The handle portion and the fitting portion are integrally formed, which can simplify the manufacturing flow of the release film 24, and the process difficulty will also be reduced.

When the release film 24 is connected to the protection film body 22, the release film 24 can protect the laminating surface of the protection film body 22 from being covered by objects such as dust. When the release film 24 is separated from the protection film body 22, the laminating surface of the protection film body 22 can be laminated on the screen. The size and shape of the fitting portion of the release film 24 adapt to the size and shape of the protection film body 22, and the laminating surface of the protection film body 22 can be well covered.

In certain implementations, the first end and the second end are located at two opposite ends of the handle portion along a lengthwise direction of the protection film body 22, and a length of the handle portion is greater than that of the protection film body 22, so that the second end is easily pulled.

In this way, a pulling force can be easily applied to the handle portion.

Specifically, the length of the handle portion may be greater than that of the protection film body 22. It can also be understood that the length of the handle portion is greater than that of the fitting portion. In this way, after the handle portion is superimposed on the fitting portion, the handle portion is provided with a protruding end (i.e., a portion of the second end used for being pulled) that is exposed from the protection film body 22 and can be pulled by human hands.

In the embodiment of the present invention, the length of the handle portion is greater than that of the fitting portion by at least a distance equal to a width of the dust removal block, so that in addition to pulling by human hands, the dust removal block can be ensured to completely sweep from a bottom end to a top end until it is separated. In the prior art, the size of the release film is the same as that of the screen, so the dust removal block cannot sweep the head of the screen, and the screen cannot be completely cleaned.

It should be noted that the lengthwise direction of the protection film body 22 mentioned in this implementation can be understood as a length extending direction of the rectangle when the protection film body 22 is a rectangle. In this way, the width of the dust removal block 38 can be made smaller, thereby saving a manufacturing material of the dust removal block 38. However, this design is not limited to this. In other implementations, when the handle portion extends along other directions of the protection film body 22, the protruding end can also be exposed at the outer edge of the protection film body 22 for pulling.

In addition, the pulling direction of the release film 24 is the same as the lengthwise direction of the protection film body 22. In this way, a moving direction of the dust removal block 38 sweeping across the screen is also the same as the lengthwise direction of the protection film body 22, so that the width of the dust removal block 38 can be smaller, without satisfying the length of the screen. Thus, the manufacturing material of the dust removal block can be saved.

In certain implementations, the width of the dust removal block 38 adapts to the width of the protection film body 22 (i.e., the width of the screen). In this way, when the dust removal block 38 sweeps across the screen, dust removal can be performed on all positions of the screen.

Specifically, the width of the dust removal block 38 in this implementation refers to a width of both ends of the dust removal block 38 in a direction perpendicular to its moving direction. When the screen resists against the release film 24, the screen is correspondingly aligned with the protection film body 22. When the dust removal block 38 moves with the release film 24, the dust removal block 38 can sweep across the screen from one end in the lengthwise direction to the other end all the way, so that dust removal can be performed on all the positions of the screen. It should be noted that the width of the screen mentioned here should consider that the screen has widths of different numerical values. In this case, the width of the dust removal block 38 adapts to the width of a maximum numerical value of the screen, as long as the dust removal block can sweep across the entire screen.

In some optional implementations, the dust removal block 38 can cover all the regions of the protection film body 22 in the lengthwise direction. Obviously, in this way, the screen can be dedusted during the dust removal movement. When the dust removal block 38 covers partial regions in the lengthwise direction of the protection film body 22, similarly, the dust removal block 38 can remove dust from the screen in the moving process. Furthermore, the manufacturing material of the dust removal block 38 can be reduced. In this way, the dust removal block 38 can effectively remove dust from the screen.

Optionally, a side edge of the dust removal block 38 facing away from a joint between the fitting portion and the handle portion may be a straight edge perpendicular to the moving direction of the dust removal block 38, or may be a straight edge inclined to the moving direction of the dust removal block 38. Much further, the side edge of the dust removal block 38 facing away from the joint between the fitting portion and the handle portion may be an irregularly shaped edge.

In some implementations, the size of the ust removal block 38 along the lengthwise direction of the protection film body 22 is less than the length of the protection film body 22.

In this way, the manufacturing material of the ust removal block 38 can be saved.

It can be understood that the size of the ust removal block 38 in this direction is less than that of the protection film body 22, which can also remove dust from the screen by the dust removal block 38, and the manufacturing material for the dust removal block can be reduced.

In certain implementations, the width of the handle portion gradually decreases from the first end to the second end.

In this way, the manufacturing material of the handle portion, that is, the manufacturing material of the release film 24, can be reduced.

It can be understood that the handle portion can be used for being pulled. Therefore, when the handle portion is pulled, the handle portion only needs to bear an applied pulling force, and the shape and size of a handle portion may not be specifically limited. In this implementation, the handle portion is provided with one end (i.e., the first end) where the dust removal block 38 is located, and the other end (i.e., the second end) facing away from the dust removal block 38. The other end can be used for applying the pulling force. The width of the handle portion from one end where the dust removal block 38 is located to the other end gradually decreases. It can also be understood that the shape of the handle portion is a trapezoid, and the exposed protruding end of the handle portion is sufficient for human hands to hold and pull. In this way, a material required for manufacturing of the handle portion can be reduced.

It should be noted that the shape of the handle portion in the above-mentioned implementation may be used as some optional implementations, which are not specifically limited. In other embodiments, the handle portion may also be in other shapes.

In this implementation, a plurality of equipment fixing bulge parts 18 are disposed around the placement surface of the placement shell 14. Furthermore, these equipment fixing bulge parts 18 form a first avoiding space in a pulling path of the release film 24. A shape and size of the first avoiding space adapt to the shape and size of the release film 24, so that the release film 24 can be pulled out of the film laminating machine 10. It should be noted that when the size of an additional component on the release film 24 is larger than that of the release film 24, for example, when the size of the dust removal block 38 is larger than that of the release film 24, the first avoiding space can also allow the additional component such as the dust removal block 38 to pass.

The protection film fixing structure 20 of this implementation can limit and fix the protection film body 22. In particular, when the release film 24 is pulled to be separated from the protection film body 22, the protection film fixing structure 20 can limit and fix the protection film body 22 in the pulling direction, which can prevent the protection film body 22 from shifting in position and can make the protection film body 22 better laminated on the screen of the equipment to be laminated with a film. After the protection film body 22 is limited and fixed, the joint between the handle portion and the fitting portion of the release film 24 is located at one end of the placement shell 14 facing away from the protection film fixing structure 20, and the handle portion is provided with a protruding end for pulling at an outer edge of one end of the placement shell 14 where the protection film fixing structure 20 is located. In this implementation, the specific structure of the protection film fixing structure 20 is set to achieve the above-mentioned limiting and fixing of the protection film body 22.

It should be noted that the protection film assembly 12 used in the film laminating machine 10 of the implementation of the present invention can be understood by taking the above protection film assembly 12 as a reference example, and the specific structures of these protection film assemblies 12 are not specifically limited.

In certain implementations, the equipment fixing bulge parts 18 form a second avoiding space opposite to the first avoiding space, and the second avoiding space adapts to the release film 24.

In this way, avoidance for the release film 24 and the dust removal block 38 can be achieved, so that the first end of the release film 24 and the dust removal block 38 can protrude and be exposed on an outer side of an edge of the screen of the equipment to be laminated with a film.

Specifically, when some of the equipment fixing bulge parts 18 are located at one end of the placement shell 14 close to the dust removal block 38, these equipment fixing bulge parts 18 can form the second avoiding space, and a shape and size of the second avoiding space adapt to the shapes and sizes of the release film 24 (especially the first end of the handle portion) and the dust removal block 38. Since the placement surface of the placement shell 14 adapts to the screen of the equipment to be laminated with a film, and the equipment fixing bulge parts 18 are disposed around the placement surface, the second avoiding space can avoid the release film 24 and dust removal block 38 which protrude and are exposed from the outer side of the edge of the screen. In addition, the second avoiding space can allow the entire protection film assembly 12 to pass, so that it is easy to place the protection film assembly into a placement space enclosed by the plurality of equipment fixing bulge parts 18.

In certain implementations, the equipment fixing bulge part 18 includes a connecting pillar body 30 and a fixing lug 32; a lower end of the connecting pillar body 30 is connected to the placement shell 14, and an upper end is connected to the fixing lug 32 that laterally extends; the equipment fixing bulge parts 18 include a first equipment fixing bulge part that forms the first avoiding space, and a second equipment fixing bulge part that forms the second avoiding space; and the first avoiding space and the second avoiding space are respectively formed between the fixing lugs of the first equipment fixing bulge part and the second equipment fixing bulge part and the placement shell.

In this way, the equipment fixing bulge parts 18 can form the first avoiding space and the second avoiding space.

Specifically, the lower end of the connecting pillar body 30 is fixedly connected to the placement shell 14, and the fixing lug 32 connected to a side portion of the upper end extend laterally, so that the connecting pillar body can be limited and fixed to an edge of the equipment to be laminated with a film. The number and position of the equipment fixing bulge parts 18 can satisfy limiting and fixing of the entire equipment to be laminated with a film. It can be conceived that extending directions of the fixing lugs 32 of the equipment fixing bulge parts 18 at different positions may be different. In the implementation of the present invention, the extending direction is based on the fact that the equipment to be laminated with a film can be limited and fixed. For example, the fixing lugs 32 of two adjacent equipment fixing bulge parts 18 can extend towards each other to limit and fix the same edge of the equipment to be laminated with a film. Optionally, the fixing lugs 32 can be arc-shaped to adapt to the edge of the equipment to be laminated with a film.

The fixing lugs 32 limit and fix the edge of the equipment to be laminated with a film, and there is a clearance space between the fixing lugs 32 and a surface of the placement shell 14. The clearance space can respectively form the above-mentioned first avoiding space and the second avoiding space according to a distribution position and function. For example, the fixing lugs 32 of the equipment fixing bulge parts 18 arranged on two opposite sides of the pulling path of the release film 24 can form the first avoiding space. The fixing lugs 32 of the equipment fixing bulge parts 18 arranged close to the dust removal block 38 and the first end can form the second avoiding space.

In certain implementations, two first equipment fixing bulge parts are provided, which are disposed on two opposite sides of the pulling path of the release film.

In this way, the first avoiding space can be formed.

Specifically, the two first equipment fixing bulge parts are disposed at one end of the placement shell 14 close to the pulling direction of the release film 24, that is, the pulling path of the release film 24 will pass through a clearance between the two first equipment fixing bulge parts. In this implementation, the fixing lugs 32 of the two first equipment fixing bulge parts extend toward each other, and the first avoiding space formed below the fixing lugs 32 of the two first equipment fixing bulge parts can be used for allowing the release film 24, the dust removal block 38 and the like to be pulled to pass. The two fixing lugs 32 extending towards each other can limit and fix the same edge of the equipment to be laminated with a film. In particular, in the pulling direction of the release film 24, it is more difficult to move the equipment to be laminated with a film during film lamination. It should be noted that in other implementations, the number of the first equipment fixing bulge parts may also be other numerical values, and the fixing lugs of the first equipment fixing bulge parts may also extend in different directions.

In certain implementations, the placement surface 16 is concave, so as to form a placement slot 26 in the placement shell 14. The placement slot 26 adapts to the protection film assembly 12.

In this way, the equipment to be laminated with a film can be placed in the placement shell 14.

Specifically, one side surface of the placement shell 14 where the placement surface 16 is located can be understood as including the placement surface 16 and other regions in addition to the placement surface 16. In this implementation, the placement surface 16 is sunken down to be lower than other regions. After the protection film assembly 12 is placed in the placement slot 26, a slot wall of the placement slot 26 can limit a periphery of the protection film assembly 12. The equipment fixing bulge parts 18 arranged around the placement surface 16 can limit and fix the equipment to be laminated with a film. When the equipment to be laminated with a film is fixed, the screen of the equipment to be laminated with a film can correspond to the protection film assembly 12 in the placement slot 26, thereby facilitating the film lamination.

In certain implementations, a thickness of the placement shell 14 is uniform, so that a material required for manufacturing of the placement shell 14 can be saved.

Specifically, the shape of the placement shell 14 can be understood as a step shape. The placement slot 26 is formed in the middle of the placement shell 14, and a wall body of the placement slot 26 extends downward. A lower side surface of the placement shell 14 is formed into a stepped surface.

Alternatively, the film laminating machine 10 may be integrally formed.

In certain implementations, the placement shell includes a first wall body located at a bottom of the placement slot 26, a second wall body located at a side portion of the placement slot 26, and a third wall body connected to an outer end of the second wall body; and the protection film fixing structure 20 is arranged on the second wall body.

In this way, the protection film fixing structure 20 can be disposed on the placement shell 14.

Specifically, the first wall body and the second wall body can be understood as slot walls of the placement slot 26, and the third wall body can be understood as a portion of the placement shell 14 other than the placement slot 26. The second wall body is located on the side portion (i.e., a side wall) of the placement slot 26, and the protection film fixing structure 20 is arranged on the second wall body, which can limit and fix the edge of the protection film body 22.

In certain implementations, the protection film fixing structure 20 is configured as a film limiting bulge part 28, and the film limiting bulge part 28 is disposed at one end of the second wall body close to the pulling direction of the release film 24.

In this way, when the release film 24 is pulled, it can be achieved that the protection film body 22 does not shift.

Specifically, the handle portion of the release film 24 is provided with an exposed protruding end (the second end) for pulling in the pulling direction. When the handle portion is pulled, the protection film body 22 will be subjected to a force in the same direction as the pulling direction. The protection film fixing structure 20 is arranged in such a way that the protection film body 22 can avoid a shift due to the force in the same direction. It can be understood that when the dust removal block 38 on the release film 24 is in close contact with the screen, during the movement, the dust removal block 38 will also apply a force in the same direction as the pulling direction to the protection film body 22. This force can cause the protection film body 22 to shift. The protection film fixing structure 20 can avoid such shift according to the above-mentioned setting. As shown in FIG. 2, the film limiting bulge parts 28 may extend in a direction opposite to the pulling direction of the release film 24. In this way, the film limiting bulge parts 28 can block an edge of the protection film body 22 in the placement slot 26. It can be conceived that when the screen of the equipment to be laminated with a film is laminated with the protection film by the film laminating machine 10, the equipment to be laminated with a film can be removed from the film laminating machine 10, and an unfitted portion between the protection film body 22 and an edge of the screen is leveled off and fitted. However, this design is not limited to this. In other implementations, the film limiting bulge parts 28 can also extend in different directions, as long as the protection film body can be limited and fixed. In addition, the protection film fixing structure 20 can also be configured as other structures, including but not limited to a rabbet.

In certain implementations, a plurality of film limiting bulge parts 28 are provided at intervals.

In this way, the protection film body 22 can be better limited and fixed.

In the implementation of the present invention, the method for limiting and fixing the protection film body is simple. The protection film body is limited and fixed by a limiting and fixing structure in a horizontal direction, and is directly integrally formed with the release film in a vertical direction, so that the production cost is greatly reduced, and additional materials such as a double-sided tape can be saved.

Specifically, the plurality of film limiting bulge parts 28 are disposed at intervals, which can limit and fix the protection film body 22 at different positions, so that the protection film body 22 is limited more stably. Further, in some optional implementations, two film limiting bulge parts 28 are provided at an interval.

In certain implementations, the placement shell 14 is provided with an avoiding via hole 34 to allow a hand of a user to pass.

In this way, it is convenient for the user to remove the equipment to be laminated with a film.

Specifically, the avoiding via hole 34 is formed in the middle of the placement shell 14, and the equipment to be laminated with a film is placed in the placement space enclosed by the plurality of equipment fixing bulge parts 18; and the equipment fixing bulge parts 18 will limit and fix the equipment to be laminated with a film. When the equipment to be laminated with a film needs to be removed from the film laminating machine 10, the user can pass through the avoiding via hole 34 with a hand to apply a force to the equipment to be laminated with a film and remove the equipment to be laminated with a film. Optionally, when the placement slot 26 is formed on the placement surface 16 of the placement shell 14, the avoiding via hole 34 is located on the bottom wall of the placement slot 26, and the avoiding via hole 34 may be a waist-shaped hole. In another aspect, by the arrangement of the avoiding via hole 34, a material required for manufacturing of the placement shell 14 can be saved, and the weight of the placement shell 14 can be reduced.

In some implementations of the present invention, a film laminating machine assembly 36 includes the film laminating machine 10 of any of the above-mentioned implementations; and a protection film assembly 12. The protection film assembly 12 includes a protection film body 22, a release film 24 and a dust removal block 38. The protection film body 22 is provided with a laminating surface used for being laminated to the screen; the release film 24 includes a fitting portion separably fitted to the laminating surface, and a handle portion used for pulling the release film 24 to be separated from the protection film body 22; the handle portion includes a first end connected to the fitting portion, and a second end for pulling; the handle portion can be superimposed on one side of the fitting portion away from the protection film body 22; and the dust removal block 38 is arranged on a surface of the first end facing away from the fitting portion, and is used for resisting against and sweeping across the screen. The protection film included in the film laminating machine assembly of this implementation can refer to the specific structure of the protection film mentioned in the aforementioned film laminating machine. Similarly, the use process of the protection film can also refer to these contents.

It should be noted that the above-mentioned explanations of the implementations and beneficial effects of the above-mentioned film laminating machine 10 are also applicable to the film laminating machine assembly 36 of this implementation, and are not described in detail here to avoid redundancy.

In one implementation of the present invention, a film laminating method based on the above-mentioned film laminating machine 10 and protection film assembly 12 is provided, including: aligning the protection film body 22 of the protection film assembly 12 with the protection film fixing structure 20 of the film laminating machine 10 for resisted placement, and limiting and fixing the protection film assembly 12 through the protection film fixing structure 20; aligning the screen of the equipment to be laminated with a film with the film laminating machine 10, placing the screen on an upper side of the placement surface of the placement shell 14 of the film laminating machine, and limiting and fixing the equipment to be laminated with a film through the fixing bulge parts 18; pulling the handle portion of the protection film assembly 12 at a constant speed until the release film 24 is completely separated from the protection film body 22, and completing film lamination.

The film laminating method of the present invention is used to laminate a film to equipment, which is quicker than the conventional film laminating method and also solves the possibility of dust entry caused by separate implementation of dust removal and film lamination.

1. A film laminating machine, which is used for laminating a protection film on a screen of equipment to be laminated with the protection film, wherein the protection film comprises a protection film body and a release film which are separably connected; the release film is pulled to be separated from the protection film body; the film laminating machine comprises a placement shell, a plurality of equipment fixing bulge parts and a protection film fixing structure;
the placement shell is provided with a placement surface fitted to the protection film; wherein the placement surface is configured to place the protection film, and the protection film body is located between the placement surface and the release film, the screen of equipment to be laminated with the protection film is configured to place on the protection film;
he equipment fixing bulge parts are disposed at intervals around the placement surface to fix the equipment to be laminated with the protection film; the equipment fixing bulge parts form a first avoiding space on a pulling path of the release film; the first avoiding space is fitted to the release film; and
the protection film fixing structure is arranged on the placement shell to limit and fix the protection film body in a pulling direction of the release film.

2. The film laminating machine according to claim 1, wherein the equipment fixing bulge parts form a second avoiding space opposite to the first avoiding space, and the second avoiding space is fitted to the release film.

3. The film laminating machine according to claim 2, wherein each said equipment fixing bulge part comprises a connecting pillar body and a fixing lug; a lower end of the connecting pillar body is connected to the placement shell, and an upper end is connected to the fixing lug that laterally extends; and
the equipment fixing bulge parts comprise a first equipment fixing bulge part that forms the first avoiding space, and a second equipment fixing bulge part that forms the second avoiding space; and the first avoiding space and the second avoiding space are respectively formed between the fixing lugs of the first equipment fixing bulge part and the second equipment fixing bulge part and the placement shell.

4. The film laminating machine according to claim 3, wherein two first equipment fixing bulge parts are configured, and the two first equipment fixing bulge parts are arranged on two opposite sides of the pulling path of the release film.

5. The film laminating machine according to claim 1, wherein the placement surface is concave, so as to form a placement slot in the placement shell; and the placement slot is fitted to the protection film.

6. The film laminating machine according to claim 5, wherein the placement shell comprises a first wall body located at a bottom of the placement slot, a second wall body located at a side portion of the placement slot, and a third wall body connected to an outer end of the second wall body; and the protection film fixing structure is arranged on the second wall body.

7. The film laminating machine according to claim 6, wherein the protection film fixing structure is configured as a film limiting bulge part; and the film limiting bulge part is arranged at one end of the second wall body close adjacent to the pulling direction of the release film.

8. The film laminating machine according to claim 7, wherein a plurality of film limiting bulge parts are disposed at intervals.

9. The film laminating machine according to claim 1, wherein an avoiding via hole is formed in the placement shell to allow a hand of a user to pass.

10. A protection film assembly, comprising:
the film laminating machine according to claim 1; and
a protection film, wherein the protection film comprises a protection film body, a release film and a dust removal block; the protection film body is provided with a laminating surface used for being laminated to the screen;
the release film comprises a fitting portion separably fitted to the laminating surface, and a handle portion used for pulling the release film to be separated from the protection film body; the handle portion comprises a first end connected to the fitting portion, and a second end for pulling; the handle portion is superimposed on one side of the fitting portion away from the protection film body; and
the dust removal block is arranged on a surface of the first end facing away from the fitting portion, and is used for resisting against and sweeping across the screen.

11. The protection film assembly according to claim 10, wherein the first end is provided with an exposed film body beyond an outer side of an edge of the protection film body close to the first end, and part of the dust removal block is arranged on one side of the exposed film body facing the screen.

12. The protection film assembly according to claim 11, wherein the dust removal block is fixedly arranged at the first end.

13. The protection film assembly according to claim 12, wherein the dust removal block is fixedly arranged at the first end by means of adhesion; and/or
one side surface of the dust removal block close to the first end is adhered to the first end; and/or
an edge of one side surface of the dust removal block facing away from the first end is adhered by part of an adhesive; and a remaining portion of the adhesive is adhered to the first end.

14. The protection film assembly according to claim 10, wherein the dust removal block is configured as clean cloth.

15. The protection film assembly according to claim 10, wherein the release film is configured as a flexible foldable film.

16. The protection film assembly according to claim 15, wherein the handle portion and the fitting portion are integrally formed.

17. The protection film assembly according to claim 10, wherein the first end and the second end are located at two opposite ends of the handle portion along a lengthwise direction of the protection film body; and a length of the handle portion is greater than that of the protection film body, so that the second end is conveniently pulled.

18. The protection film assembly according to claim 10, wherein a width of the dust removal block is fitted to a width of the protection film body; and/or
a size of the dust removal block along a lengthwise direction of the protection film body is less than a length of the protection film body.

19. The protection film assembly according to claim 10, wherein a width of the handle portion gradually decreases from the first end to the second end.

20. A film laminating method based on the protection film assembly according to claim 10, comprising:
S1, aligning the protection film body of the protection film assembly with the protection film fixing structure of the film laminating machine for resisted placement, and limiting and fixing the protection film assembly through the protection film fixing structure;
S2, aligning the screen of the equipment to be laminated with a film with the film laminating machine, placing the screen on an upper side of the placement surface of the placement shell of the film laminating machine, and limiting and fixing the equipment to be laminated with a film through the fixing bulge parts; and
S3, pulling the handle portion of the protection film assembly at a constant speed until the release film is completely separated from the protection film body, and completing film lamination.
